(19) United States
(12) Patent Application Publication
(10) Pub. No.: US 2022/0410417 A1
(43) Pub. Date: Dec. 29, 2022

(54) SCISSORS WITH REMOVABLE TAPERED RAZOR ASSEMBLY

(71) Applicants: Kourtney Shuman, Bemus Point, NY (US); Eric Matthew Shuman, Bemus Point, NY (US)

(72) Inventors: Kourtney Shuman, Bemus Point, NY (US); Eric Matthew Shuman, Bemus Point, NY (US)

(21) Appl. No.: 17/822,328

(22) Filed: Aug. 25, 2022

Related U.S. Application Data
(63) Continuation-in-part of application No. 16/911,588, filed on Jun. 25, 2020.

(51) Int. Cl. B26B 13/22; B26B 21/40

(52) U.S. Cl. CPC B26B 13/22; B26B 21/4037

(57) ABSTRACT

A tapered razor assembly arranged to be removably inserted into a slot disposed on a static blade member of a scissors. The tapered razor assembly includes a razor blade having a base extending from a back end to a tip end, the razor blade having a pair of side surfaces extending from the base, the pair of side surfaces arranged to terminate at a cutting edge, the cutting edge tapering from the base end to the tip end, a guard member fixedly secured to one of the pair of the surfaces, the guard having a guard end, a base, and a tip, and a cover member fixedly secured to one of the pair of side surfaces, the cover having a base and a tip, wherein the guard member and the cover member sandwich the razor blade.

### CROSS-REFERENCE TO RELATED APPLICATIONS

This application is a continuation-in-part of U.S. patent application Ser. No. 16/911,588, filed Jun. 25, 2020, and claims priority thereto pursuant to 35 U.S.C. § 120, which application is incorporated by reference in its entirety.

### FIELD OF THE INVENTION

The present invention relates to hair styling scissors to aid hair stylists in cutting and styling hair in a more efficient manner and a removable and tapered razor. The present invention also relates to a tapered razor assembly.

### BACKGROUND OF THE INVENTION

For many hair stylists, success comes not only from the quality of the work, but also from the speed at which they provide their service. The more customers a stylist or hairdresser can service in a given day, the more revenue they can earn. However, the introduction of new technology has caused hair styles to become more complex, requiring stylists to become familiar with new technologies to accommodate any requested style. This creates a problem. For a stylist to be successful, he or she must learn how to use these tools in the most efficient way possible.

One tool that has become more and more popular over the years is the feather razor. A feather razor is used to give hair more volume. It does so by layering the hair and taking away unwanted weight in the hair so that it does not lay flat to the head. Almost every hair stylist has a feather razor and uses it regularly. Depending on the style of haircut requested, the hair stylist may have to switch between his or her scissors and the feather razor countless times throughout the cut. Switching back and forth, while trying to maintain efficiency, can cause injuries to the stylist and the customer, and add unnecessary time to the service, necessarily reducing the potential revenue a stylist can earn during a single work-day.

In U.S. Pat. No. 4,805,305 a combination razor and scissor device is disclosed. A first jaw of pair of scissors comprises a recess for securing a razor. This combination device eliminates the need for a stylist to have a separate razor and pair of scissors. A problem with this particular device, however, is that the razor cartridge is inserted proximate the sharp point of the blades, risking injury. Another problem with this prior art device is that a stylist can only use the razor of the device with the scissors in an open position, which further increases the risk of injury.

Hair trimming razors are known in the art. These razors have finger rings on the rear or other portions of the handle as disclosed in U.S. Pat. No. 6,092,288. A problem with this particular device, however, is that the razor cartridge is inserted proximate the sharp point of the blades, risking injury.

U.S. Published Patent Application No. 2007/0209214 discloses a combination hair tool that comprises a scissor and a razor. The combination hair tool comprises two scissor blade portions operatively arranged to be pivotably connected, wherein one of the scissor blade portions includes a fixedly secured razorblade holder including a blade holder slot, a handle portion, and a finger ring. The combination tool razor blade scissor portion accepts a slidably secured razor blade from the opposite end of the finger ring towards the pivoting connection. A problem with this particular device, however, is that the razor cartridge is inserted proximate the sharp point of the blades, risking injury.

Another issue pertains to a removable razor disposed within a slot within a scissor's blade member. Traditional feather razors have a substantially rectangular arrangement, such that the traditional feather razor creates a distance between the side opposite of the scissor's blade and the sharp edge of the razor—creating a potential snag point that could introduce unnecessary injury and/or risk, while potentially slowing down a hairstylist during a haircut.

Thus, there is a long felt need for a pair of scissors with a removable feather razor that allows a hair stylist to cut hair with scissors and style hair with a feather razor in a single tool, safely securing the razor, while allowing a stylist to adjust a rotatably secured finger loop.

There is also a long-felt need for a pair of scissors with a removable feather razor held in a cartridge, which cartridge is installable into the scissor blade from the finger ring part of the scissors.

There is an additional long felt need for a pair of scissors with a removable feather razor where the removable razor is tapered, such that the tip of the removable feather razor seamless transitions into the opposite side of a scissor's blade.

Further, there is yet another long felt need for a pair of scissors with a tapered removable feather razor that is arranged to be inserted into a slot disposed on the opposite side of the scissor's blade, where the slot is closed proximate to the tip of the scissor's blade and the slot is open proximate to the handle of the scissor.

Even further there is a long felt need for a razor blade assembly having a tapered razor blade secured adjacently to at least one guard member having a respective tapered configuration.

### SUMMARY OF THE INVENTION

The present invention broadly comprises a scissors with removable feather razor, comprising a static blade member having a blade portion, said blade portion having a tip at a first end and a handle portion at a second end, wherein said blade portion has a cutting edge and a back edge and said handle portion has a static neck portion and a static finger ring extending therefrom, said static blade member also having an aperture to accommodate a tension screw, said aperture located between said first end and said second end, and closer to said first end than said second end, said blade portion having a slot therein, said slot closed proximate said tip portion, said slot arranged parallel to said cutting edge of said static blade member, said slot arranged to extend leftwardly and rightwardly of said aperture; a dynamic blade member having a blade portion, said blade portion having a tip at a first end and a handle portion at a second end, wherein said blade portion has a cutting edge and a back edge and said handle portion has a dynamic neck portion and a dynamic finger ring extending therefrom, said dynamic blade member also having an aperture to accommodate said tension screw, said aperture located between said first end and said second end, and closer to said first end than said second end; and, a tension screw operatively arranged to pass through both said static blade aperture and said dynamic blade aperture to hold said static blade member and said dynamic blade member in close proximity to one another and form a pivot point about which both said static blade member and said dynamic blade member are operatively arranged to pivot relative to one another.

The present invention also generally comprises a static blade member for a scissors with a tapered razor assembly having a blade portion, the blade portion having a back edge extending from a tip of the blade portion to a neck portion of the static blade member, the neck portion arranged opposite of the tip, a slot arranged within the back edge, and a tapered razor assembly having a tapered razor fixedly secure therein arranged to be removably inserted into the slot at the open end, the tapered razor assembly having a dovetail extending from a first end of the assembly proximate the tip, the dove tail arranged to rest on the back edge of the blade portion.

The present invention also generally includes a tapered razor assembly. The tapered razor assembly includes a tapered razor assembly arranged to be removably inserted into a slot disposed on a static blade member of a scissors. The tapered razor assembly includes a razor blade having a base extending from a back end to a tip end, the razor blade having a pair of side surfaces extending from the base, the pair of side surfaces arranged to terminate at a cutting edge, the cutting edge tapering from the base end to the tip end, a guard member fixedly secured to one of the pair of the surfaces, the guard having a guard end, a base, and a tip, and a cover member fixedly secured to one of the pair of side surfaces, the cover having a base and a tip, wherein the guard member and the cover member sandwich the razor blade.

The tapered razor assembly of the present invention also generally comprises a guard and an outer cover arranged to fixedly sandwich the tapered razor therebetween, the guard comprises a guard end and a base end, the guard end having a substantially sinusoidal outer edge configuration, where both the guard and the cover have a tapered configuration.

A general object of the invention is to provide an adjustable and removeable blade and scissor device that allows a stylist to use a feather razor and scissor simultaneously.

A secondary object of the invention is to provide a pair of scissors with a removeable razor blade, which blade is held in a cartridge, and which cartridge is insertable into one of the blades of the scissors from the end of the scissors closest to the finger rings.

A further object of the invention is to provide a combination scissors/feather razor blade assembly wherein the pair of scissors includes a pivot point about which the pair of scissor blades pivot, and wherein a cartridge containing the feather razor overlaps or straddles the pivot point to achieve an optimally balanced pair of scissors.

Another object of the invention is to provide a combination scissors/feather razor blade assembly is to provide for a tapered feather razor within a removable razor cartridge (i.e., tapered razor assembly), where the tapered razor assembly includes a dovetail arranged to abut and rest on a back side of a blade member of the scissors, where the dovetail includes a tip arranged to extend past a tip end of the tapered feather razor.

An even further objection of the invention is to provide a combination scissors/feather razor blade having a tapered feather razor within a removable tapered razor assembly, where the tapered razor assembly includes a dovetail extending therefrom to eliminate a snag point that traditional, substantially rectangular-shaped, feather razors create when inserted into the removable razor cartridge.

These and other objects of the invention will become apparent upon review of the following detailed description of the invention in view of the drawings and appended claims.

### BRIEF DESCRIPTION OF THE DRAWINGS

The nature and mode of the operation of the present invention will now be more fully described in the following detailed description of the invention taken with the accompanying drawing figures, in which:

FIG. 1 is a left side view of the present invention in an open position;

FIG. 2 is a right-side view of the invention in FIG. 1 in an open position showing a user holding the invention;

FIG. 3 is a left-front perspective view of the invention in FIG. 1 in an open position;

FIG. 4 is a right-front perspective view of the invention in FIG. 1 in an open position;

FIG. 5 is a left-front perspective view of the invention in FIG. 1 in a closed position;

FIG. 6 is a right-front perspective view of the invention in FIG. 1 in a closed position;

FIG. 7A is a cross-sectional view of the invention's static blade member without a removable razor cartridge in place, which view is taken generally along line 7A shown in FIG. 1;

FIG. 7B is a cross-sectional view of the invention's static blade member with a removable razor cartridge installed therein, which view is taken generally along line 7B-7B shown in FIG. 1;

FIG. 8 is a fragmentary cross-sectional view of the invention's static blade member, which view is taken generally along line 8-8 in FIG. 7A;

FIG. 9 is an exploded view of the invention shown in FIG. 1;

FIG. 10 is the fragmentary cross-sectional view of the invention's static blade member shown in FIG. 8;

FIG. 11 is a left side view of the invention's static blade member;

FIG. 12 is a left side view of scissor/tapered-razor combination 10′ having tapered razor assembly 100 in an open position;

FIG. 13 is a right-side view of the invention in FIG. 12 in an open position showing a user holding the invention;

FIG. 14 is a left-front perspective view of the invention in FIG. 12 in an open position;

FIG. 15 is a right-front perspective view of the invention in FIG. 12 in an closed position;

FIG. 16 is a front-perspective view of tapered razor assembly 100;

FIG. 17 is a rear-perspective view of tapered razor assembly 100;

FIG. 18 is a perspective exploded view of tapered razor assembly 100 shown in FIG. 17;

FIG. 19 is a top plan exploded view of tapered razor assembly 100;

FIG. 20A is a cross-sectional view taken generally along line 20A-20A in FIG. 12, without tapered razor assembly 100 therein;

FIG. 20B is a cross-sectional view taken generally along line 20A-20A in FIG. 12; and,

FIG. 21 is an exploded view of static blade member 11 and tapered razor assembly 100.

### DETAILED DESCRIPTION OF THE INVENTION

The terminology used herein is for the purpose of describing particular embodiments only and is not intended to be limiting of the invention.

As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art, that the present invention may be practiced without these specific details. It should be appreciated that direction terms such as “left”, “right”, “upper”, “lower”, and similar derivatives are made in reference to the corresponding drawings and should not be restrictively read into the appending claims. Likewise, the corresponding drawings are exemplary examples and should not be viewed to scale.

The present disclosure is to be considered as an exemplification of the invention, and is not intended to limit the invention to the specific embodiments illustrated by the figures or description below.

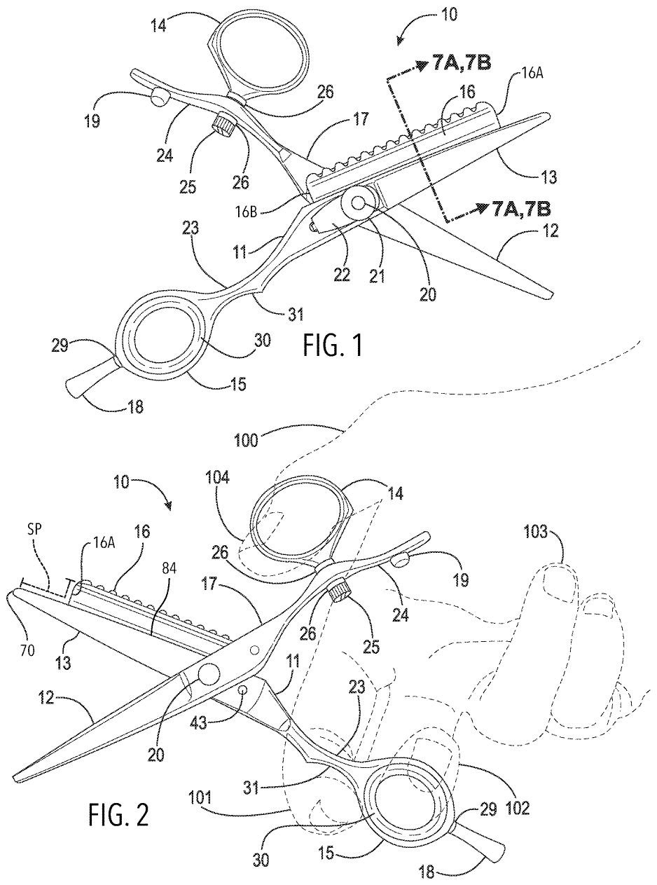

The present invention will now be described by referencing the appended figures. The following description should be read in view of FIGS. 1-6. FIG. 1 is a right-side view of the scissor and removable feather razor in an open position. Scissor razor combination 10 broadly comprises dynamic blade member 17, static blade member 11, and removeable razor cartridge 16. Dynamic blade member 17 and static blade member 11 are pivotably attached by way of tension screw 20 that is secured by lock nut 21 and tab 22, discussed further infra.

Dynamic blade member 17 further comprises dynamic blade cutting edge 12, dynamic blade member neck 24, dynamic finger ring 14, and bumper 19. Dynamic finger ring 14 is threadably secured to dynamic blade member neck 24 by finger ring tension screw and spacers 26. Bumper 19 is threadably secured to dynamic blade member neck 24.

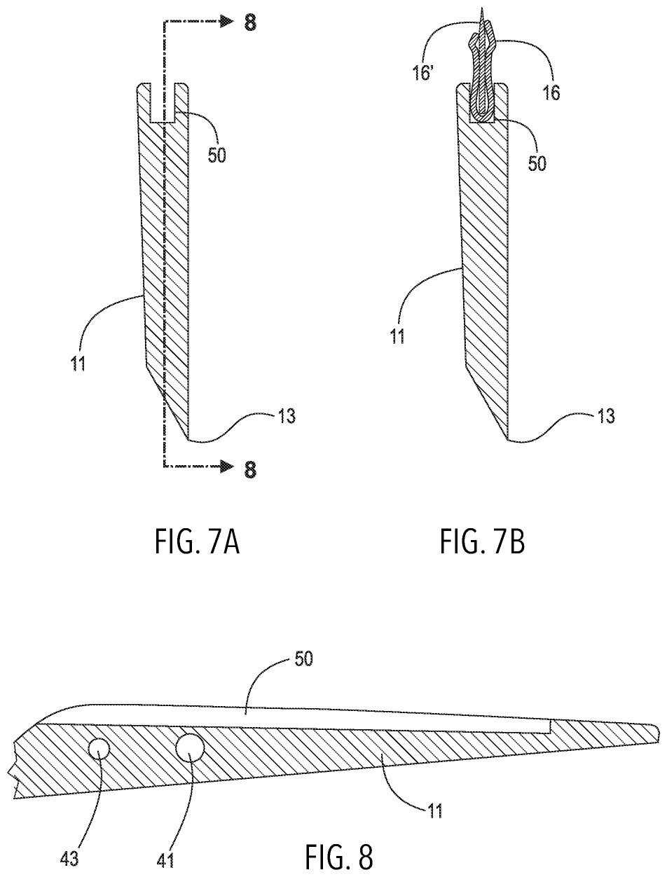

Static blade member 11 further comprises static blade cutting edge 13, static blade member neck 23, removable razor cartridge 16, static finger ring 15, rubber finger guard 30, finger rest 18, neck finger rest 31, and slot 50 (shown in FIGS. 7A-8), discussed further infra. Finger rest 18 is threadably secured to static finger ring 15 and has finger rest washer 29 arranged on a male threaded member.

FIG. 2 is a left side view of scissor razor combination 10 with user right hand 100 holding the invention for use. FIG. 2 is further described infra.

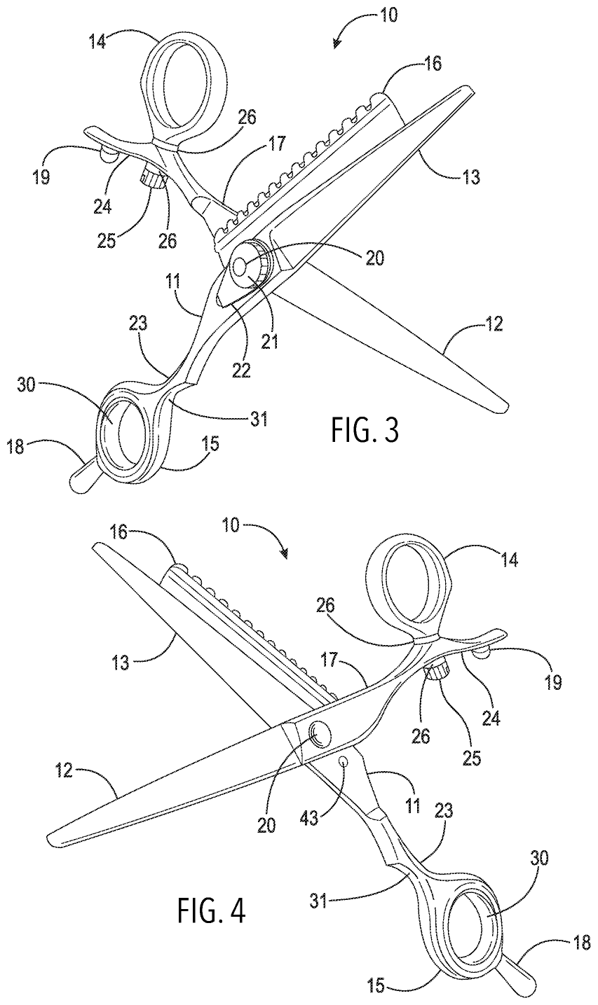

FIG. 3 is a right-front perspective view of scissor razor combination 10 in an open position.

FIG. 4 is a left-front perspective view of scissor razor combination 10 in an open position.

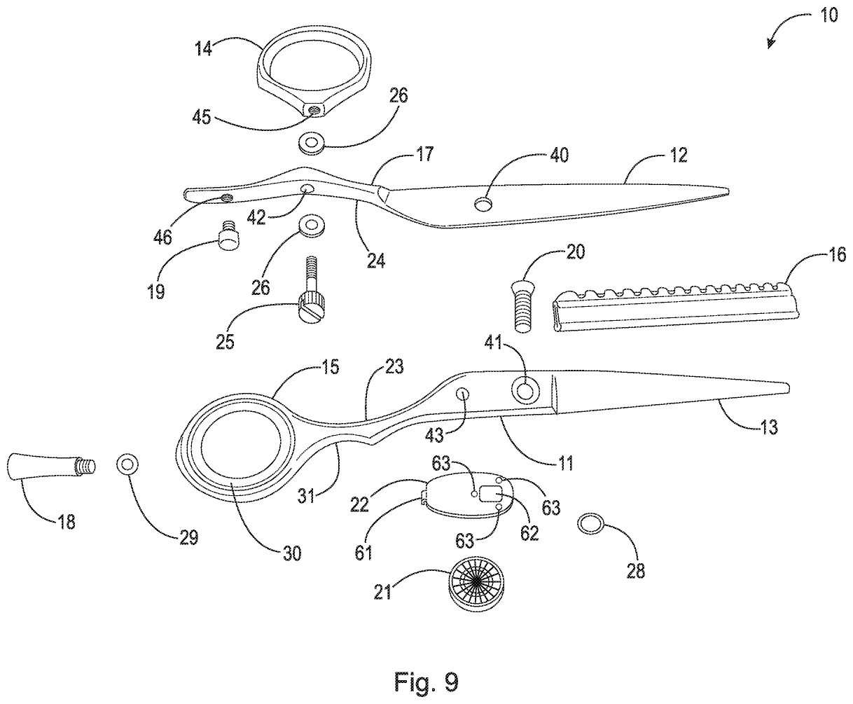

The following description should be read in view of FIGS. 3-4 and FIG. 9. Blade member tension screw 20 rotatably secures dynamic blade member 17 and static blade member 11 through substantially centered dynamic blade member aperture 40 and substantially centered static blade member aperture 41. Static blade member aperture 41 is countersunk and operatively arranged to accept cone washer 28. Tab 22 comprises tab hook 61, tab aperture 62, and protrusions 63. The tab aperture 62 of tab 22 is operatively arranged to accept tension screw 20. Tension screw 20 is secured by lock nut 21. Lock nut 21 comprises a plurality of ridges operatively arranged to contact and frictionally secure lock nut 21 to protrusions 63 on the surface of tab 22. Tab aperture 62 is operatively arranged to accept tab hook 61 to prevent rotation when threadably secured by tension screw 20 and lock nut 21. Hook aperture 43 may also be a depression operatively arranged to accept tab hook 61 of tab 22.

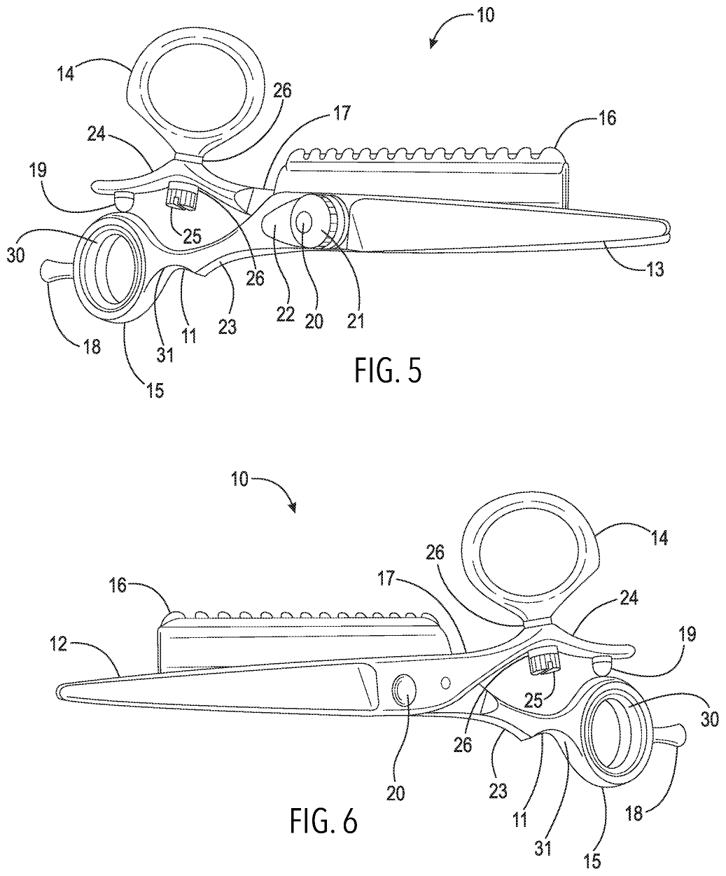

The following description should be read in view of FIG. 5 and FIG. 6. FIG. 5 is a left-front perspective view of scissor razor combination 10 in a closed position. FIG. 6 is a right-front perspective view of scissor razor combination 10 in a closed position. Bumper 19 is operatively arranged to contact outer surface of static finger ring 15. Bumper 19 prevents scissor razor combination 10 from closing further to prevent snagging hair if the respective blades were to pass the range restriction created by bumper 19. Bumper 19 also provides a user feedback as bumper contacts the surface of static finger ring 15.

Adverting now to FIGS. 7A-8: FIG. 7A shows a cross-sectional front view of static blade member 11 cut along line 7A shown in FIG. 1 without removable razor cartridge 16; FIG. 7B shows a cross-sectional front view of static blade member 11 cut along line 7B shown in FIG. 1 with removable razor cartridge 16 in place in slot 50; FIG. 8 shows a partial left side view of static blade member 11 cut along line 8 shown in FIG. 7A with razor cartridge 16 removed from slot 50. The following description should be read in view of all figures. Removable razor cartridge 16 holds razor blade 16′. Removable razor slot 50 is centrally disposed in static blade member 11 within the opposite surface of static blade member cutting edge 13. Removable razor cartridge 16 is frictionally secured within removable razor slot 50 by outwardly pushing edges that contact the inner surfaces of removable razor slot 50. Removable razor slot 50 terminates before the tip of static blade member 11 as shown in FIG. 8. Removable razor cartridge 16 substantially straddles the pivot point at tension screw 20 at dynamic blade aperture 40 and static blade aperture 41. Removable razor cartridge 16 is slidably inserted into removable razor slot 50 towards static blade member neck 23 end towards static blade member cutting edge 13. Removable razor slot 50 extends in length in a direction opposite of the tip of static blade member 11. The length of removable razor slot 50, in the direction opposite static blade member 11 tip and in the direction of hook aperture 43, is shorter than the length of removable razor slot 50 that extends in the direction of static blade member 11 towards the tip, relative to static blade member aperture 41, as illustrated in FIG. 8.

Adverting now to FIG. 2; FIG. 2 shows scissor razor combination 10 held in right hand 100. Dynamic finger ring 14 is operatively arranged to access thumb 104 to hold dynamic blade member 17. Dynamic finger ring 14 is rotatably adjustable to accommodate thumb 104 resting within to the most ideal and comfortable position for a user, reducing fatigue that fixed thumb rings may cause. Static finger ring 15 is operatively arranged to accept middle finger 102. Static finger ring comprises inner finger guard 30 to protect middle finger 102 from sustained use, reducing fatigue from continual use. Neck finger rest 31 is operatively arranged to provide a contoured and ergonomic surface for index finger 101 to rest. Static blade member 11 also includes finger rest 18 that is operatively arranged to optionally allow ring finger 103 to also rest thereon, further improving comfort for a user over prolonged use.

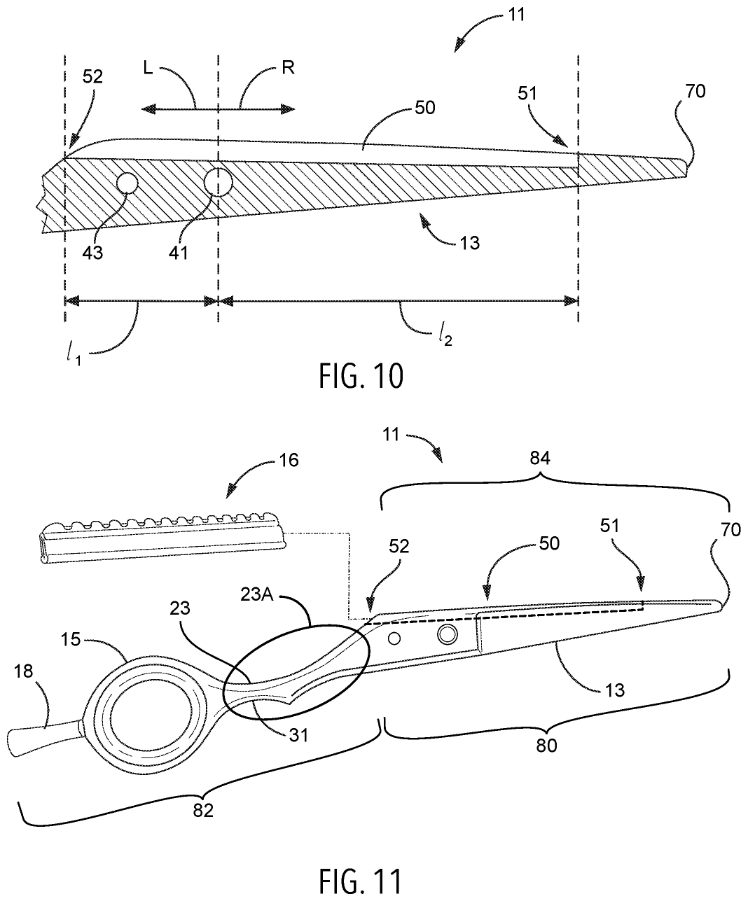

FIG. 10 illustrates the fragmentary cross-sectional view of static blade member 11 shown in FIG. 8. Slot 50 includes closed end 51 and open end 52. Slot 50 is further arranged to extend in leftward direction L relative to static blade member aperture 41 and to extend in rightward direction R relative to static blade member aperture 41. Slot 50 extends in leftward direction L a length l₁ towards open end 52, terminating slot 50 thereat. Slot 50 extends in rightward direction R a length l₂ towards closed end 51, terminating slot 50 thereat. Length l₁ is less than length l₂.

FIG. 11 illustrates a left side view of static blade member 11, specifically illustrating removable razor cartridge 16 disengaged with slot 50, whereas slot 50 is illustrated in broken lines. Static blade member 11 in a preferred embodiment includes blade portion 80 having cutting edge 13, tip 70, and, back edge 84. Back edge 84 is arranged on the opposite side of cutting edge 13. Extending from back edge 84 and cutting edge 13 is neck portion 23A. Neck portion 23A is defined by the section between open end 52 of slot 50 and static finger ring 15 within handle portion 82, specifically including neck 23 and neck finger rest 31. Handle portion 82 includes neck portion 23A, neck 23, neck finger rest 31, specifically neck finger rest 31 is located on the same side as cutting edge 13. Handle portion 82 also includes static finger ring 15 and finger rest 18. As described supra, handle portion 82 is defined by the components that engage fingers 101, 102, and 103 of right hand 100, as shown in FIG. 2. Removable razor cartridge 16 is arranged to be slid into slot 50 from open end 52 in the direction towards closed end 51, engaging slot 50 as illustrated in FIG. 7B. This configuration eliminates the risk of injury related to a razor cartridge being inserted proximate a sharp tip of a blade member.

To use removable razor 16, scissor razor combination 10 is moved to a closed position shown in FIGS. 5 and 6. A user would comb a section or layer of hair and pull removable razor 16 up or down that section or layer to create a textured or feathered look.

### Tapered Razor Assembly & Scissor/Tapered-Razor Combination

Adverting now to the scissors with a removable and tapered feather razor of the present invention, scissor/tapered-razor combination 10′. It should be noted that only the differences between scissor/tapered-razor combination 10′ and scissor/razor combination 10 include tapered razor assembly 100 compared to removable razor cartridge 16 and slot 50′ compared to slot 50. Notably, the configuration of tapered razor assembly 100 of scissor/tapered-razor combination 10′ removes snag point SP, created by scissor tip end 16A of removable razor cartridge 16 and back edge 84 of scissor/razor combination 10, as shown in FIG. 2.

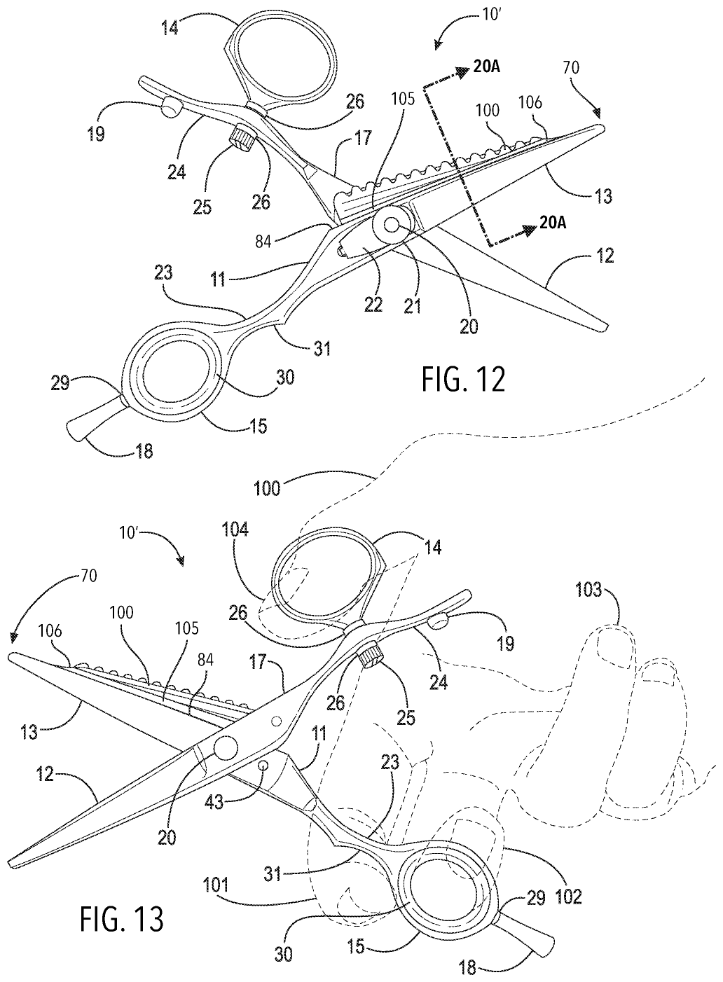

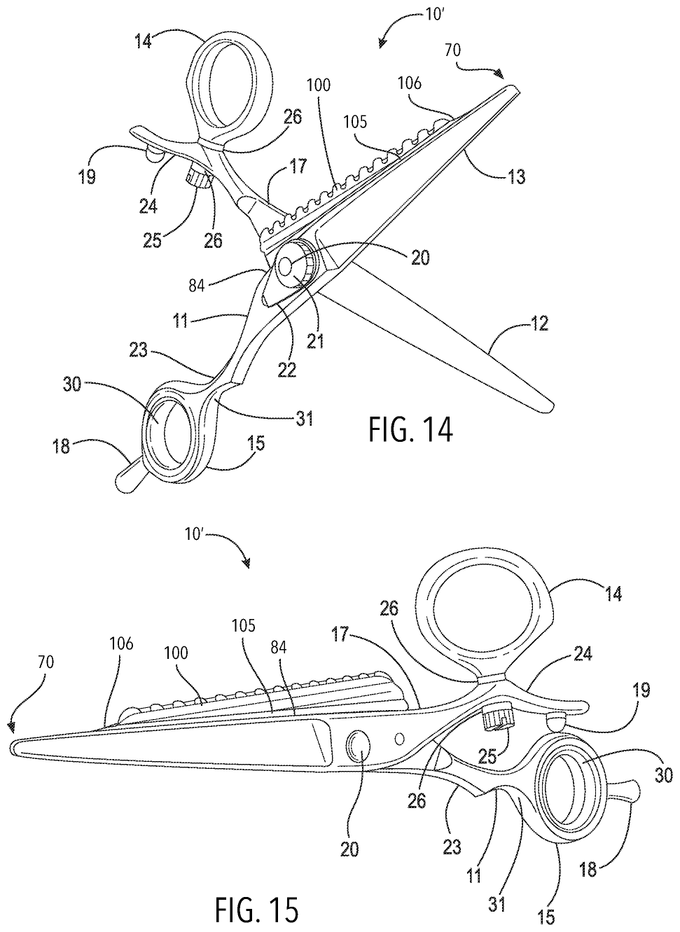

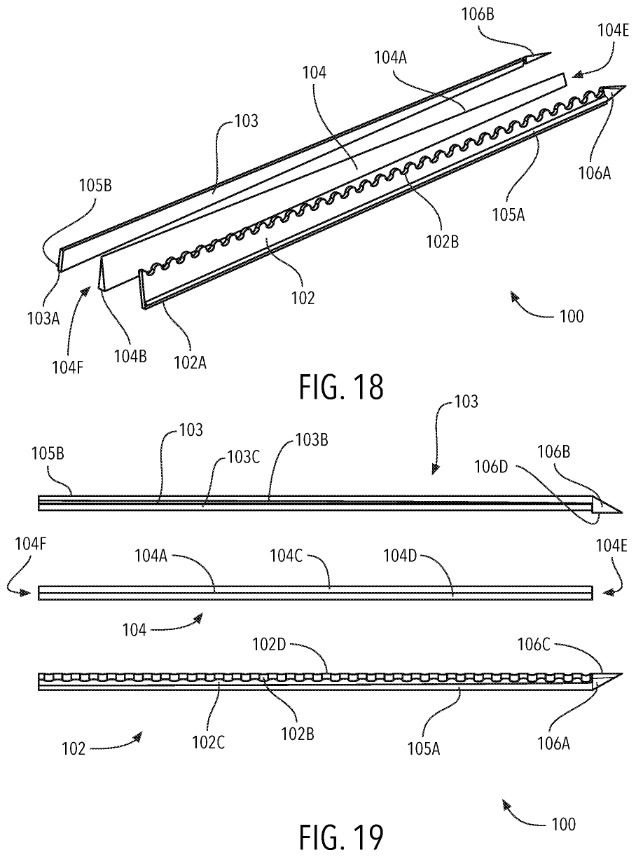

The following description should be taken in view of FIGS. 12 through 15, which generally illustrate: a left side view in an open configuration; a right side view in an open configuration; a left front perspective view in an open configuration; a right front perspective view in an open configuration; and, a right front perspective view in a closed configuration, of scissor/tapered-razor combination 10′, respectively. Scissor/tapered-razor combination 10′ notably includes tapered razor assembly 100 which generally includes dovetail 105 extending from two respective sides and tip 106 of dovetail. Dovetail 105 of tapered razor assembly 100 is arranged to rest on back edge 84 of static blade member 11 when tapered razor assembly 100 is disposed within slot 50′ (shown in FIGS. 18A and 18B).

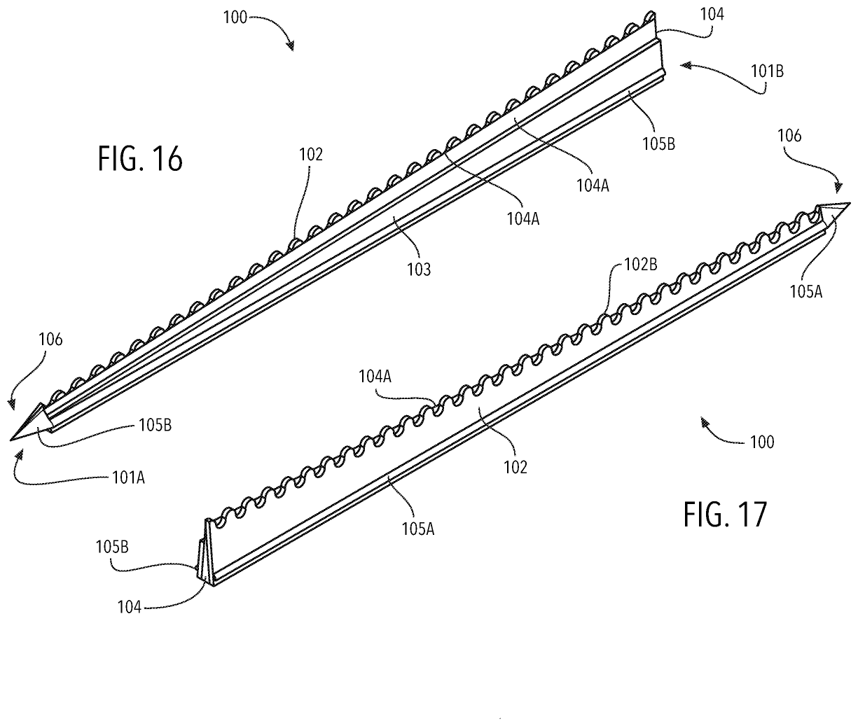

The following description should be taken in view of FIGS. 16 through 19. FIG. 16 generally illustrates a front perspective view of tapered razor assembly 100 and FIG. 17 generally illustrates a rear perspective view of the same. FIG. 18 generally illustrates a perspective exploded view of tapered razor assembly 100 and FIG. 19 is a top plan exploded view of the same.

Tapered razor assembly 100 is preferably arranged to have tip end 101A and back end 101B. Tapered razor assembly 100 generally includes guard 102, cover 103, and tapered razor 104 secured therebetween. Guard 102 comprises base 102A, guard end 102B, external surface 102C, and internal surface 102D. Cover 103 comprises base 103A, external surface 102B, and internal surface 103C. Tapered razor 104 comprises cutting edge 104A, base 104B, first surface 104C, second surface 104D, tip end 104E, and back end 104F. Guard 102 also includes dovetail 105A extending from external surface 102C. Dovetail 105A includes tip 106A having internal surface 106C. Cover 103 also includes dovetail 105B extending from external surface 103B. Dovetail 105B includes tip 106B having internal surface 106D.

Guard end 102B preferably has a sinusoidal configuration and has a tapered configuration that generally follows the tapered configuration of tapered razor 104, that is, guard end 102B has a back end vertical height (proximate to back end 104F of tapered razor 104) that is greater than a tip end vertical height (proximate to tip 106A of dovetail 105A).

Cover 103 has a tapered configuration that generally follows the tapered configuration of tapered razor 104, that is, cover 103 has a back end vertical height (proximate to back end 104F of tapered razor 104) that is greater than a tip end vertical height (proximate to tip 106B of dovetail 105B).

Tapered razor 104 has a tapered configuration where the vertical height is greater proximate to back end 104F than the vertical height proximate to tip end 104E.

When tapered razor assembly 100 is assembled, internal surface 102D of guard 102 is fixedly secured to surface 104D of tapered razor 104 and internal surface 103C of cover 103 is fixedly secured to surface 104C of tapered razor 104. In a preferred embodiment, guard 102 and cover 103 are melted onto the respective surfaces of tapered razor 104. However, it should be appreciated that alternative securement means may be contemplated, such as fasteners, snap-fit protrusions arranged on cover 103 and guard 102 and respective attachment apertures arranged within tapered razor 104.

When tapered razor assembly 100 is assembled, internal surface 106C of tip 106A of dovetail 105A is arranged to be fixedly secured to internal surface 106D of tip 106B of dovetail 105B—forming dovetail 105 of tapered razor assembly 100. Dovetail 105 is arranged at tip end 101A of tapered razor assembly 100.

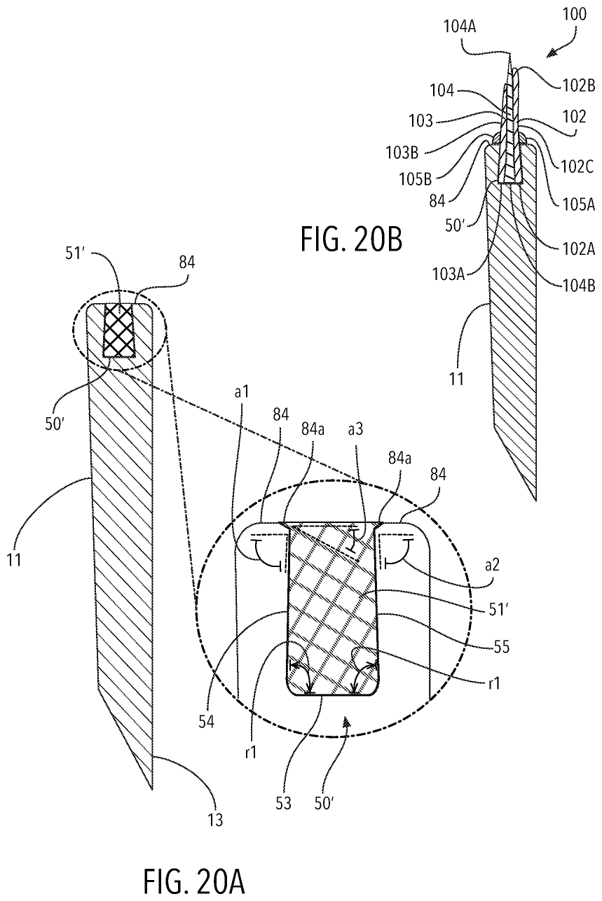

The following description should be taken in consideration of FIGS. 20A and 20B. FIG. 20A is a cross-sectional view taken generally along line 20A-20A in FIG. 12 and FIG. 20B is a cross-sectional view taken generally along line 20A-20A in FIG. 12. FIG. 20A specifically illustrates slot 50′ without tapered razor assembly 100 therein and FIG. 20B specifically illustrates slot 50′ with tapered razor assembly 100 therein.

Slot 50′ shares many of the configurations of slot 50 (shown in FIG. 11). Specifically, both slot 50′ and slot 50 have closed ends 51 (shown in FIG. 11) and 51′, respectively. Both slot 50′ and slot 50 have open ends 52 (shown in FIG. 11) and 52′ (shown in FIG. 20). Slot 50′ generally opens into static blade member 11 from back edge 84, specifically opening into chamfer 84a. Chamfer 84a terminates into walls 54 and 55 and slot 50′, where walls 54 and 55 merge into base 53 of slot 50′. It should be noted that chamfer 84a may, or may not, be present in slot 50′.

In a preferred embodiment, angle a1 of slot 50′ is approximately 45°, angle a2 of slot 50′ is approximately 45°, and angle a3 of slot 50′ is approximately 45°. It should be appreciated that the preferred angles of angles a1-a3 are merely exemplary and alternative angles may be acceptable and contemplated.

In a preferred embodiment, radii r1 and r2 are approximately 0.03″. It should be appreciated that the preferred radius of radii r1 and r2 are merely exemplary and alternative radii may be acceptable and contemplated—however, r1 and r2 should be substantially equal.

As shown in FIG. 20B, tapered razor assembly 100 is arranged to be slidably inserted into slot 50′, such that bases 102A, 103A, and 104B all rest on base 53 of slot 50′ and external surfaces 102C (of guard 102) and 103B (of cover 103) contact walls 55 and 54 of slot 50′, respectively. Dovetails 105A and 105B are also arranged to rest on back edge 84 when tapered razor assembly 100 is inserted within slot 50′.

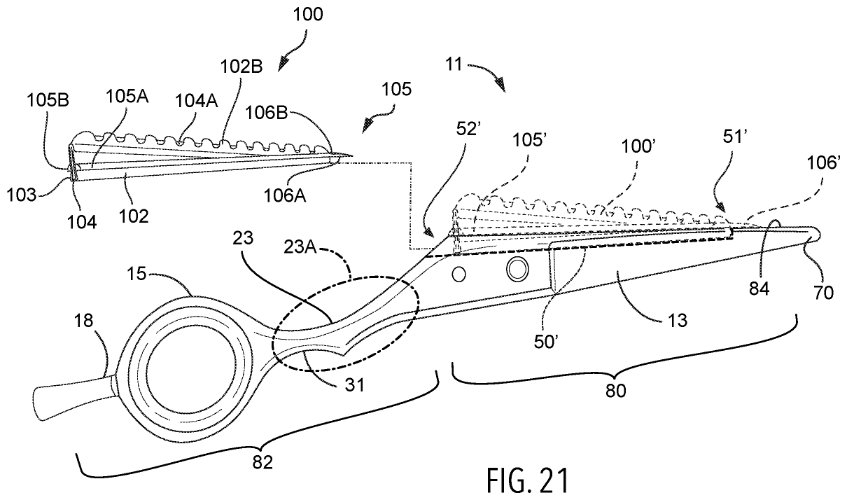

FIG. 21 generally illustrates static blade member 11 having slot 50′ (illustrated in hidden lines). As shown, tapered razor assembly 100 is arranged to be inserted into slot 50′ from open end 52′ until the respective tip ends of tapered razor 104, cover 103, and guard 102 abut closed end 51′ of slot 50′. FIG. 21 also shows tapered razor assembly 100′ (in broken lines) within slot 50′, such that tip 106′ of dovetail 105′ extends past closed end 51′ of slot 50′ and rests on back edge 84—removing snag point SP (shown in FIG. 2), and such that dovetail 105′ rests on back edge 84.

It should be noted that tapered razor 104 may comprise a plurality of grind-types, such as a flat grind, a full hollow grind, a half hollow grind, or other similar grinds known within the art.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 scissor/razor combination
10′ scissor/tapered-razor combination
11 static blade member
12 dynamic blade cutting edge
13 static blade cutting edge
14 dynamic finger ring
15 static finger ring
16 removable razor cartridge
16A scissor tip end of removable razor cartridge 16
16B scissor neck end of removable razor cartridge 16
17 dynamic blade member
18 finger rest
19 threaded bumper
20 blade member tension screw
21 lock nut
22 tab
23 static blade member neck
23A neck portion of static blade 11
24 dynamic blade member neck
25 finger ring tension screw
26 spacer
28 cone washer
29 finger rest washer
30 rubber finger guard
31 neck finger rest
40 dynamic blade member aperture
41 static blade member aperture
42 finger ring aperture
43 hook aperture
44 finger rest aperture
45 threaded bumper aperture
46 threaded finger ring aperture
50 slot
50′ slot
51 closed end of slot 50
51′ closed end of slot 50′
52 open end of slot 50
52′ open end of slot 50′
53 base of slot 50′
54 wall of slot 50′
66 wall of slot 50′
61 tab hook
62 tab aperture
63 frictional bumps
70 tip of static blade member 11
80 blade portion of static blade member 11
82 handle portion of static blade member 11
84 back edge of static blade member 11
84a chamfer of back edge 84 into slot 50′
100 tapered razor assembly
100′ tapered razor assembly
101A tip end of tapered razor assembly 100
101B back end of tapered razor assembly 100
102 guard of tapered razor assembly 100
102A base of guard 102
102B guard end of guard 102
102C external surface of guard 102
102D internal surface of guard 102
103 outer cover of tapered razor assembly 100
103A base of outer cover 103
103B external surface of cover 103
103C internal surface of cover 103
104 tapered razor of tapered razor assembly 100
104A cutting edge of tapered razor 104
104B base of tapered razor 104
104C first surface of tapered razor 104
104D second surface of tapered razor 104
104E tip of tapered razor 104
104F back end of tapered razor 104
105 dovetail of tapered razor assembly 100
105′ dovetail of tapered razor assembly 100
105A dovetail of guard 102
105B dovetail of cover 103
106 tip of dovetail 105
106′ tip of dovetail 105′
106A tip of dovetail 105A
106B tip of dovetail 105B
106C internal surface of tip 106A
106D internal surface of tip 106B
a1 angle of 84 and 54
a2 angle of 84 and 55
a3 angle of 84 and 84a
L leftward direction
R rightward direction
r1 radius of 53 and 55
r2 radius of 84 and 84a
SP snag point of removable razor cartridge 16 and back edge 84
l₁ length
l₂ length

What is claimed is:

1. A static blade member for a scissors with a removable razor assembly, comprising:
a blade portion, said blade portion having a back edge extending from a tip of said blade portion to a neck portion of said static blade member, said neck portion arranged opposite of said tip;
a slot arranged within said back edge; and,
a removable razor assembly having a tapered razor fixedly secured therein arranged to be removably inserted into an open end of said slot, said removable razor assembly having a dovetail extending from a first end having a tip, said dovetail arranged to rest on said back edge of said blade portion.

2. The static blade member for a scissors with the removable razor assembly recited in claim 1, wherein said blade portion of said static blade member further comprises an aperture therein, said aperture arranged proximate to said neck portion, wherein said slot includes a closed end arranged opposite said open end, said slot further arranged to extend a first length relative to said aperture towards said open end, said slot arranged to extend a second length relative to said aperture towards said closed end, wherein said second length of said slot is greater than said first length of said slot.

3. A scissors having the static blade member recited in claim 2, said scissors further comprising a dynamic blade member, said dynamic blade member having a blade portion, said blade portion of said dynamic blade member having an aperture arranged therein, said dynamic blade member having a neck extending from said blade portion arranged oppositely from a tip of said blade portion, and said neck having a dynamic finger ring rotatably secured thereon, wherein said aperture of said static blade member and said aperture of said blade portion of said dynamic blade member are both arranged to accept a tension screw therein, said tension screw rotatably arranged to secure said dynamic blade member to said static blade member.

4. The static blade member for a scissors with the removable razor assembly recited in claim 1, wherein said slot includes a closed end arranged opposite said open end, said open end of said slot arranged proximate said neck portion, said closed end of said slot arranged proximate said tip of said blade portion.

5. The static blade member for a scissors with the removable razor assembly recited in claim 1, wherein said tapered razor includes a cutting edge, said cutting edge arranged to taper from a second end of said removable razor assembly and terminate at said dovetail of said removable razor assembly.

6. The static blade member for a scissors with the removable razor assembly recited in claim 5, wherein said removable razor assembly further comprises a guard and an outer body arranged to fixedly sandwich said tapered razor therebetween.

7. The static blade member for a scissors with the removable razor assembly recited in claim 6, wherein said guard and said outer body are made of a plastic, where said guard and said outer body are fixedly secured to said tapered razor via melting.

8. The static blade member for a scissors with the removable razor assembly recited in claim 6, wherein said guard comprises a guard end and a base end, said guard end having a substantially sinusoidal outer edge configuration.

9. The static blade member for a scissors with the removable razor assembly recited in claim 8, wherein said tapered razor has a base end arranged opposite said cutting edge, said base end having a full hollow configuration.

10. The static blade member for a scissors with the removable razor assembly recited in claim 1, wherein said slot comprises an upper opening and a base, wherein said base has a first width and said upper opening has a second width, wherein said first width is greater than said second width thereby preventing said removable razor assembly from disengaging said slot from said upper opening.

11. A tapered razor assembly, comprising:
a razor blade having a base extending from a back end to a tip end, said razor blade having a pair of side surfaces extending from said base, said pair of side surfaces arranged to terminate at a cutting edge, said cutting edge tapering from said base end to said tip end;
a guard member fixedly secured to one of said pair of side surfaces, said guard having a guard end, a base, and a tip; and,
a cover member fixedly secured to one of said pair of side surfaces, said cover having a base and a tip, wherein said guard member and said cover member sandwich said razor blade.

12. The tapered razor assembly recited in claim 11 further comprising a dovetail extending from said guard member, said dovetail having a tip extending past said tip end of said razor blade.

13. The tapered razor assembly recited in claim 11 further comprising a dovetail extending from said cover member, said dovetail having a tip extending past said tip end of said razor blade.

14. The tapered razor assembly recited in claim 11 further comprising a first dovetail extending from an outer surface of said guard member, said first dovetail terminating into a tip, said tip of said first dovetail arranged to extend past said tip end of said razor blade; and, a second dovetail extending from an outer surface of said cover member, said second dovetail terminating into a tip, said tip of said second dovetail arranged to extend past said tip end of said razor blade, wherein said tip of said first dovetail and said tip of said second dovetail are arranged to be fixedly secured thereto.

15. The tapered razor assembly recited in claim 11, wherein said guard end comprises a substantially sinusoidal guard edge configuration, said guard edge arranged to tapered from said back end of said razor blade to said tip end of razor blade.

16. A static blade member for a scissors, comprising:
a blade portion, said blade portion having a back edge extending from a tip of said blade portion to a neck portion of said static blade member, said neck portion arranged opposite of said tip;
a slot arranged within said back edge; and,
the tapered razor assembly recited in claim 15 further arranged to be removably inserted within said slot, wherein said first dovetail and said second dovetail are arranged to rest on said back edge.

17. The static blade member for a scissors recited in claim 16, wherein said slot includes an open end arranged proximate said neck portion and a closed end arranged proximate said tip of said blade portion of said static blade member.

18. The static blade member for a scissors with the removable razor assembly recited in claim 17, wherein said blade portion of said static blade member further comprises an aperture therein, said aperture arranged proximate to said neck portion, wherein said slot is further arranged to extend a first length relative to said aperture towards said open end, said slot is arranged to extend a second length relative to said aperture towards said closed end, wherein said second length of said slot is greater than said first length of said slot.

19. A scissors having the static blade member recited in claim 18, said scissors further comprising a dynamic blade member, said dynamic blade member having a blade portion, said blade portion of said dynamic blade member having an aperture arranged therein, said dynamic blade member having a neck extending from said blade portion arranged oppositely from a tip of said blade portion, and said neck having a dynamic finger ring rotatably secured thereon, wherein said aperture of said static blade member and said aperture of said blade portion of said dynamic blade member are both arranged to accept a tension screw therein, said tension screw rotatably secures said dynamic blade member and said static blade member.
